(19) United States
(12) Patent Application Publication
(10) Pub. No.: US 2014/0335366 A1
(43) Pub. Date: Nov. 13, 2014

(54) Anti-Reflective Coating

(71) Applicant: Leibniz-Institut fuer Neue Materialien gemeinnuetzige GmbH, Saarbruecken (DE)

(72) Inventors: Peter William de Oliveira, Saarbruecken (DE); Elisabete Henriquetta Soares de Carvalho Menezes, Recife-PE (BR); Mohammad Hossein Jilavi, Kirkel (DE); Peter Koenig, Lebach (DE)

(21) Appl. No.: 14/366,015

(22) PCT Filed: Dec. 14, 2012
(86) PCT No.: PCT/EP2012/075492

§ 371 Date: Jun. 17, 2014

(30) Foreign Application Priority Data
Dec. 30, 2011 (DE) 10 2011 057 180.9

(51) Int. Cl. C09D 5/00; G02B 1/11

(52) U.S. Cl. CPC C09D 5/006; G02B 1/111
USPC 428/447; 528/354; 427/162

(57) ABSTRACT

An anti-reflective coating is obtained from a composition of at least one silane compound, at least one metal compound and at least one organic compound having at least two functional groups which can form a coordination polymer.

### FIELD OF THE INVENTION

The invention relates to an antireflective coating, more particularly a single-layer antireflective coating, and also to a method for producing such a coating, and its use.

### PRIOR ART

Physical vapor deposition (PVD) and chemical vapor deposition (CVD) are customary methods for producing antireflective coatings. However, the vacuum units needed for these methods make the production of such coatings very expensive, especially for large surface areas. Wet-chemical techniques, such as the sol-gel technique, are favorable methods for producing antireflective coatings, including for large surface areas. Generally speaking, high-value antireflective coatings are achieved by means of multilayer coatings. This is not only time-consuming but also expensive, not least on account of the more involved thermal curing. It has emerged that the industry therefore needs single-layer coatings for large areas and large unit volumes, such as for solar cells, for example. Single-layer coatings of these kinds display broadband transmission of the solar spectrum, as required specifically for solar cells.

In accordance with methods customary to date, single-coat or single-layer antireflective coats of these kinds are produced from porous SiO₂ in a sol-gel process.

The porosity of the coatings, not least as a result of the included air, reduces the refractive index of the coating from a theoretical 1.5 (pure SiO₂) to 1.1-1.45, depending on the porosity and on the method of production of the SiO₂ matrix (1, 2, 3, 4, 5). The porosity must therefore be controlled precisely in order to obtain high-value coatings.

One known class of compounds which develop porous structures are the coordination polymers, more particularly the so-called metal-organic frameworks (MOFs) (6, 7, 8, 9, 10). These are compounds which consist of metal-organic centers bridged via ligands. In these compounds, through the appropriate choice of the ligands and of the metal-organic centers, it is possible to adjust the porosity of the resulting structure. At the same time, the solvent or solvent mixture used may also play a part. These compounds are employed primarily in the area of catalysis, since the metal centers present often have a catalytic effect as well. Generally speaking, therefore, the compounds are also not heat-treated, since in that case these capacities are lost. Antireflective coatings with MOFs are unknown.

It is an object of the invention, therefore, to provide an antireflective coating which permits better control of the porosity of the coating.

This object is achieved by the inventions having the features of the independent claims. Advantageous developments of the inventions are characterized in the subclaims. The wording of all of the claims is hereby made part of the content of this description by reference. The inventions also encompass all rational, and more particularly all stated, combinations of independent and/or dependent claims.

The object is achieved by means of a coating composition which comprises at least one hydrolyzable silane compound, at least one hydrolyzable metal compound, it also being possible for the compound to be in partially hydrolyzed and/or condensed form, at least one organic compound having at least two functional coordinative groups or precursors thereof, and at least one solvent.

The term “at least one organic compound having at least two functional coordinative groups” identifies an organic compound which contains at least two functional groups capable of developing coordinative bonds to a given metal ion. Preference here is given to organic groups which are able to develop two or more functional bonds. Preference is given here to organic compounds which are able via the functional groups to form coordinative bonds to two or more, preferably two, metal atoms. Such preferred compounds are particularly suitable for the construction of coordination polymers.

Without being tied to any particular theory, it is assumed that coordination polymers, more particularly MOFs, are formed in the composition. This purpose is served in particular by the hydrolyzable metal compound and the organic compound. However, the silane compound as well will have participated in the formation of the MOF. Overall, the construction of a coordination polymer of this kind has the advantage of forming, in the composition, a defined framework, leading to defined pore formation.

These coordinative bonds need not be formed to one individual compound. It is also possible for the organic compound to join condensates of the metal compound and/or of the silane compound. It is of course also possible for some of the compounds which have not participated in the MOF to undergo incorporation within the pores.

The defined structure within the composition is also very important for the antireflective coating produced. To produce the antireflective coating, the applied composition is heat-treated. In the course of this treatment, the solvent is removed and the organic constituents, i.e., including the organic compounds, are generally burnt out. In spite of this, the structure that is formed in the composition has an influence on the structure of the later antireflective coat, more particularly on its porous structure, which is important for the resultant refractive index. In this way it is possible, through a defined structure in the composition, to influence the structure of the subsequent antireflective coating.

The composition comprises at least one hydrolyzable silane compound. This is preferably a compound of the formula

R¹ₐSiX₄₋ₐ (I)

where X stands for one or more hydrolyzable radicals, which may be identical or different.

Suitable examples of hydrolyzable radicals X in the above formulae are hydrogen, halogen (F, Cl, Br or I, more particularly Cl or Br), alkoxy (e.g., C₁₋₆ alkoxy, such as methoxy, ethoxy, n-propoxy, isopropoxy, and n-, iso-, sec-, or tert-butoxy), aryloxy (preferably C₆₋₁₀ aryloxy, such as phenoxy), alkaryloxy, e.g., benzoyloxy, acyloxy (e.g., C₁₋₆ acyloxy, preferably C₁₋₄ acyloxy, such as acetoxy or propionyloxy), and alkylcarbonyl (e.g., C₂₋₇ alkylcarbonyl such as acetyl). Likewise suitable are NH₂, amino mono- or disubstituted by alkyl, aryl and/or aralkyl, where examples of the alkyl, aryl and/or aralkyl radicals are those indicated below for R¹, amido such as benzamido, or aldoxime or ketoxime groups. Two or three groups X may also be joined to one another, as in the case of Si-polyol complexes with glycol, glycerol or pyrocatechol, for example. The stated groups may optionally contain substituents, such as halogen, hydroxyl, alkoxy, amino, or epoxy. Preferred hydrolytically eliminable radicals X are halogen, alkoxy groups, and acyloxy groups. Particularly preferred hydrolytically eliminable radicals are C₁₋₄ alkoxy groups, more particularly methoxy and ethoxy.

Here, a may adopt the value 0, 1, or 2; preferred silanes are those with a being 0 or 1, more preferably with a being 0. These are silanes having four hydrolyzable radicals, which are preferably all the same.

R¹ stands for one or more nonhydrolyzable radicals. These are, for example, alkyl (e.g., C₁₋₂₀ alkyl, more particularly C₁₋₄ alkyl, such as methyl, ethyl, n-propyl, isopropyl, n-butyl, isobutyl, sec-butyl, and tert-butyl), alkenyl (e.g., C₂₋₂₀ alkenyl, more particularly C₂₋₄ alkenyl, such as vinyl, 1-propenyl, 2-propenyl, and butenyl), alkynyl (e.g., C₂₋₂₀ alkynyl, more particularly C₂₋₄ alkynyl, such as ethynyl or propargyl), aryl (more particularly C₆₋₁₀ aryl, such as phenyl and naphthyl), and corresponding aralkyl and alkaryl groups, such as tolyl and benzyl, and cyclic C₃-C₁₂ alkyl and alkenyl groups, such as cyclopropyl, cyclopentyl, and cyclohexyl.

The radicals R¹ may have customary substituents, which may be functional groups via which crosslinking is possible as well if need be. Customary substituents are, for example, halogen (e.g., chlorine or fluorine), epoxide (e.g., glycidyl or glycidyloxy), hydroxyl, ethers, esters, amino, monoalkylamino, dialkylamino, optionally substituted anilino, amide, carboxyl, alkenyl, alkynyl, acryloyl, acryloyloxy, methacryloyl, methacryloyloxy, mercapto, cyano, alkoxy, isocyanato, aldehyde, keto, alkylcarbonyl, acid anhydride, and phosphoric acid. These substituents are bonded to the silicon atom via divalent bridging groups, more particularly alkylene, alkenylene, or arylene bridging groups, which may be interrupted by oxygen or —NH— groups. The bridging groups contain, for example, 1 to 18, preferably 1 to 8, and more particularly 1 to 6 carbon atoms. The stated divalent bridging groups are derived, for example, from the aforementioned monovalent alkyl, alkenyl, or aryl radicals. The radical R¹ may of course also have more than one functional group.

Preferred examples of nonhydrolyzable radicals R¹ having functional groups via which crosslinking is possible are a glycidyl or a glycidyloxy-(C₁₋₂₀)-alkylene radical, such as β-glycidyloxyethyl, γ-glycidyloxypropyl, δ-glycidyloxybutyl, ε-glycidyloxypentyl, ω-glycidyloxyhexyl, and 2-(3,4-epoxycyclohexyl)ethyl, a (meth)acryloyloxy-(C₁₋₆)-alkylene radical, e.g., (meth)acryloyloxymethyl, (meth)acryloyloxyethyl, (meth)acryloyloxypropyl, or (meth)acryloyloxybutyl, and a 3-isocyanatopropyl radical. Particularly preferred radicals are γ-glycidyloxypropyl and (meth)acryoyloxypropyl. (Meth)acryloyl here stands for acryloyl and methacryloyl.

Preferred radicals R¹ which are used are radicals without substituents or functional groups, more particularly alkyl groups, preferably having 1 to 4 carbon atoms, more particularly methyl and ethyl, and also aryl radicals such as phenyl.

Examples of silane compounds of the formula (I) are methyltrimethoxysilane, methyltriethoxysilane, ethyltriethoxysilane, isobutyltrimethoxysilane, isobutyltriethoxysilane, octyltriethoxysilane, octyltrimethoxysilane, (3-glycidyloxypropyl)methyldiethoxysilane, (3-glycidyloxypropyl)trimethoxysilane, phenyltrimethoxysilane, or phenyltriethoxysilane, tetraalkoxysilanes such as tetramethoxysilane (Si(OCH₃)₄), tetraethoxysilane (Si(OC₂H₅)₄), tetrapropoxysilane (Si(O-n- or iso-C₃H₇)₄, Si(OC₄H₉)₄, and also SiCl₄, HSiCl₃, Si(OOCCH₃)₄, or mixtures of such silane compounds, preference being given to tetraalkoxysilanes such as tetramethoxysilane (Si(OCH₃)₄), tetraethoxysilane (Si(OC₂H₅)₄), tetrapropoxysilane Si(O-n- or iso-C₃H₇)₄, Si(OC₄H₉)₄, and also SiCl₄, HSiCl₃, Si(OOCCH₃)₄, or mixtures thereof. Particularly preferred are tetraalkoxysilanes such as tetramethoxysilane or tetraethoxysilane, or mixtures thereof.

The composition further comprises a hydrolyzable metal compound.

The metal compound is a hydrolyzable metal compound, in other words containing at least one group that can be replaced by reaction with water—that is, which is hydrolytically eliminable.

Such compounds are, for example, halides, such as fluorides, chlorides, bromides, or iodides, alkoxides, carboxylic acid compounds, cyanides, or sulfides.

In a development of the invention, the compound is a compound of the formula (II):

MXₙ (II)

where M is selected from the groups Ia, IIa, IIIa, IVa to VIa, and Ib to VIIIb. Particularly preferred are Mg, Ca, Sr, Ba, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, B, Al, Ga, In, Tl, Si, Ge, Sn, Pb, As, Sb, and Bi. Particularly preferred are Zn, Al, Mg, Ca, Ti, Zr, Cu, Ni, Fe, Pd, Pt, Ru, Rh, and Co. Especially preferred are Zn, Al, Ti, Zr, Ni, Cu, Mg, Ca, Fe. With regard to the ions of these elements, those particularly noteworthy are Mg²⁻, Ca²⁺, Sr²⁺, Ba²⁺, Sc³⁺, Y³⁺, Ti⁴⁺, Zr⁴⁻, Hf⁴⁺, V⁴⁺, V³⁺, V²⁺, Nb³⁺, Ta³⁻, Cr³⁺, Mo³⁺, W³⁻, Mn³⁺, Mn²⁺, Re³⁺, Re²⁺, Fe³⁺, Fe²⁺, Ru³⁺, Ru²⁺, OS³⁻, OS²⁺, Co³⁺, Co²⁺, Rh²⁺, Rh⁺, Ir²⁺, Ir⁺, Ni²⁺, Ni⁺, Pd²⁺, Pd⁺, Pt²⁻, Pt⁻, Cu²⁺, Cu⁺, Ag⁺, Au⁺, Zn²⁺, Cd²⁺, Hg²⁺, Al³⁻, Ga³⁺, In³⁺, Tl³⁻, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁻, Sb³⁺, Sb⁺, Bi⁵⁺, Bi³⁺, and Bi⁺. In the formula, n corresponds to the valence of the metal.

Likewise possible for use are, for example, hydrolyzable compounds of elements of main groups I and II of the Periodic Table (e.g., Na, K, Ca, and Mg), and of transition groups V to VIII of the Periodic Table (e.g., Mn, Cr, Fe, and Ni). Hydrolyzable compounds of the lanthanoids such as Ce may also be used. Preferred metal compounds are those where M is Al, B, Sn, Fe, Ti, Zr, V, or Zn, preferably Al, Fe, Ti, or Zr, with Ti being particularly preferred. Mixtures of two or more metal compounds may also be employed.

X is a hydrolyzable radical which is preferably as defined in formula (I); two groups X may be replaced by one oxo group.

Preferred metal compounds are, for example, the alkoxides or halides of B, Al, Zr, and especially Ti. Suitable hydrolyzable metal compounds are, for example, Al(OCH₃)₃, Al(OC₂H₅)₃, Al(O-n-C₃H₇)₃, Al(O-iso-C₃H₅)₃, Al(O-n-C₄H₉)₃, Al(O-sec-C₄H₉)₃, AlCl₃, AlCl(OH)₂, Al(OC₂H₄OC₄H₉)₃, TiCl₄, Ti(OC₂H₅)₄, Ti(O-n-C₃H₇)₄, Ti(O-i-C₃H₇)₄, Ti(OC₄H₉)₄, Ti(2-ethylhexoxy)₄, ZrCl₄, Zr(OC₂H₅)₄, Zr(O-n-C₃H₇)₄, Zr(O-i-C₃H₇)₄, Zr(OC₄H₉)₄, ZrOCl₂, Zr(2-ethylhexoxy)₄, and also Zr compounds or Ti compounds which have complexing radicals, such as β-diketone and (meth)acryloyl radicals, boric acid, BCl₃, B(OCH₃)₃, B(OC₂H₅)₃, SnCl₄, Sn(OCH₃)₄, Sn(OC₂H₅)₄, VOCl₃, and VO(OCH₃)₃, for example. The metal compounds may also be in partially or fully hydrolyzed form, e.g., TiOCl₂. This can be achieved by reacting these compounds with water before they are added to the composition, preferably with an excess of water, in an excess of 2 to 10 times for example, measured relative to the hydrolyzable groups of the compound, i.e., 2 to 10 mol of water per mole of hydrolyzable group. The hydrolysis may alternatively take place using stoichiometric or substoichiometric amounts of water.

Functional groups of the at least one organic compound via which the stated coordinative bonds may be formed include, in particular, the following functional groups, for example: —CO₂H, —NH₂, —OH, —SH, —CS₂H, —NO₂, —B(OH)₂, —SO₃H, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, with R, for example, preferably an alkylene group having 1, 2, 3, 4, or 5 carbon atoms such as, for example, a methylene, ethylene, n-propylene, isopropylene, n-butylene, isobutylene, tert-butylene, or n-pentylene group, or an aryl group, containing 1 or 2 aromatic nuclei such as 2 C₆ rings, for example, which may optionally be fused and independently of one another may be substituted by at least one substituent in each case in a suitable way, and/or which independently of one another may each include at least one heteroatom such as N, O and/or S, for example. In accordance with likewise-preferred embodiments, functional groups wherein the above-stated radical R is not present should be mentioned. Such groups include —CH(SH)₂, —C(SH)₃, —CH(NH₂)₂, —C(NH₂)₃, —CH(OH)₂, —C(OH)₃, —CH(CN)₂, or —C(CN)₃.

Preferred groups are amino group, carboxylic acid groups, hydroxyl groups, and thiols, or precursors of such groups, with carboxylic acids being preferred.

Precursors of carboxylic acid groups are, for example, anhydride groups, esters, or amides. The compound may also comprise a plurality of different such groups and/or precursors.

The at least two functional groups may in principle be bonded to any suitable organic compound, provided it is ensured that the organic compound containing these functional groups is capable of forming the coordinative bond and of producing the framework material, i.e., of coordinative bonding to at least one metal compound and/or at least one silane compound.

The organic compounds which contain the at least two functional groups derive preferably from a saturated or unsaturated aliphatic compound or from an aromatic compound, or from a both aliphatic and aromatic compound.

The aliphatic compound or the aliphatic moiety of the both aliphatic and aromatic compound may be linear and/or branched and/or cyclic, with a plurality of rings per compound also being possible. With further preference, the aliphatic compound or the aliphatic moiety of the both aliphatic and aromatic compound comprises 1 to 15, more preferably 1 to 14, more preferably 1 to 13, more preferably 1 to 12, more preferably 1 to 11, and especially preferably 1 to 10 C atoms such as, for example, 1, 2, 3, 4, 5, 6, 7, 8, 9, or 10 C atoms. Especially preferred in this context are, among others, methane, adamantane, acetylene, ethylene, or butadiene.

The aromatic compound or the aromatic moiety of the both aromatic and aliphatic compound may have one or else two or more nuclei such as, for example, two, three, four, or five nuclei, it being possible for the nuclei to be present separately from one another and/or for at least two nuclei to be present in fused form. With particular preference the aromatic compound or the aromatic moiety of the both aliphatic and aromatic compound has one, two, or three nuclei, in which case one or two nuclei are particularly preferred. Independently of one another, moreover, each nucleus in the stated compound may comprise at least one heteroatom such as, for example, N, O, S, B, P, Si, Al, preferably N, O and/or S. With further preference the aromatic compound or the aromatic moiety of the both aromatic and aliphatic compound comprises one or two C₆ nuclei, in which case the two are present either separately from one another or fused form. Aromatic compounds include, in particular, benzene, naphthalene and/or biphenyl and/or bipyridyl and/or pyridyl.

Mention should be made for example, among others, of trans-muconic acid or fumaric acid or phenylenebisacrylic acid.

Examples in the context of the present invention are dicarboxylic acids such as, for instance, oxalic acid, succinic acid, tartaric acid, 1,4-butanedicarboxylic acid, 4-oxopyran-2,6-dicarboxylic acid, 1,6-hexane-dicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazol-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidodicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octandicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-dinaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)-phenyl-3-(4-chloro)-phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyl ether diimidodicarboxylic acid, 4,4′-diaminodiphenylmethanediimidodicarboxylic acid, 4,4′-diaminodiphenyl sulfone diimidodicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, diphenyl ether 4,4′-dicarboxylic acid, imidazole-4,5-dicarboxylic acid, 4-(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptandicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubine-4,11-dicarboxylic acid, 7-chloro-3-methylquinoline-6,8-dicarboxylic acid, 2, 4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecane-dicarboxylic acid, 5,6-dehydronorbornane-2,3-dicarboxylic acid, or 5-ethyl-2,3-pyridinedicarboxylic acid, tricarboxylic acids such as, for instance, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, or aurinetricarboxylic acid, or tetracarboxylic acids such as, for instance, 1,1-dioxidoperylo[1,12-BCD]thiophene-3,4,9,10-tetra-carboxylic acid, perylenetetracarboxylic acids such as perylene-3,4,9,10-tetracarboxylic acid or perylene-1,12-sulfonyl-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid, or cyclopentanetetracarboxylic acids such as cyclopentane-1,2,3,4-tetracarboxylic acid.

Especially preferred is the use of optionally at least singly substituted mono-, di-, tri-, tetra-, or more highly poly-cyclic aromatic dicarboxylic, tricarboxylic, or tetracarboxylic acids, it being possible for each of the nuclei to comprise at least one heteroatom, and for two or more nuclei to comprise identical or different heteroatoms. Preference for example is given to monocyclic dicarboxylic acids, monocyclic tricarboxylic acids, monocyclic tetracarboxylic acids, dicyclic dicarboxylic acids, dicyclic tricarboxylic acids, dicyclic tetracarboxylic acids, tricyclic dicarboxylic acids, tricyclic tricarboxylic acids, tricyclic tetracarboxylic acids, tetracyclic dicarboxylic acids, tetracyclic tricarboxylic acids and/or tetracyclic tetracarboxylic acids. Suitable heteroatoms are, for example, N, O, S, B, P, Si, Al; preferred heteroatoms here are N, S and/or O. A suitable substituent in this respect is, among others, —OH, a nitro group, an amino group, or an alkyl or alkoxy group.

Especially preferred for use as at least bidentate organic compounds are acetylenedicarboxylic acid (ADC), benzenedicarboxylic acids, naphthalenedicarboxylic acids, biphenyldicarboxylic acids such as, for example, 4,4′-biphenyldicarboxylic acid (BPDC), bipyridinedicarboxylic acids such as, for example, 2,2′-bipyridinedicarboxylic acids such as, for example, 2,2′-bipyridine-5,5′-dicarboxylic acid, benzenetri-carboxylic acids such as, for example, 1,2,3-benzenetricarboxylic acid or 1,3,5-benzenetricarboxylic acid (BTC), 1,3,5,7-adamantanetetracarboxylic acid (ATC), adamantane dibenzoate (ADB), benzene tribenzoate (BTB), methane tetrabenzoate (MTB), adamantane tetrabenzoate, 1,2,4,5-benzenetetracarboxylic acid, or dihydroxyterephthalic acids such as, for example, 2,5-dihydroxyterephthalic acid (DHBDC), 1,2,4,5-benzenetetracarboxylic acid (=pyromellitic acid), 3,3′-4,4′-biphenyltetracarboxylic acid, 3,3′-4,4′-benzophenonetetracarboxylic acid (=3,3′-4,4′-benzoylbenzenetetracarboxylic acid), 3,3′-4,4′-isopropylidenediphthalic acid, 3,3′-4,4′-oxydiphthalic acid, and (hexafluoroisopropylidene)diphthalic acid.

Especially preferred for use are, among others, isophthalic acid, terephthalic acid, 2,5-dihydroxyterephthalic acid, 1,2,3-benzenetricarboxylic acid, 1,3,5-benezenetricarboxylic acid, 1,2,4,5-benzenetetracarboxylic acid, or 2,2′-bipyridine-5,5′-dicarboxylic acid.

Besides the aforementioned compounds it is also possible to use precursors or variants of these acids, such as, for example, their anhydrides, esters, or amides. If solvents with hydroxyl groups are used, such as lower alcohols, for example, such as methanol, ethanol, isopropanol, or tert-butanol, the corresponding esters may also be formed in the composition. In the case of the use of anhydrides, the number of free acid groups can be adjusted via the addition of water. The anhydrides are especially preferred when the carboxylic acid groups present in the organic compound are able to form a cyclic anhydride within the compound. For the particularly preferred compounds, a corresponding anhydride of this kind is 1,2,4,5-benzenetetracarboxylic 1,2:4,5-dianhydride.

In addition to these at least bidentate organic compounds, the MOF may also comprise one or more unidentate ligands.

Suitable solvents for preparing the MOF include water, alcohols, preferably lower aliphatic alcohols (C₁-C₈ alcohols), such as methanol, ethanol, 1-propanol, isopropanol, and 1-butanol, ketones, preferably lower dialkyl ketones, such as acetone and methyl isobutyl ketone, ethers, preferably lower dialkyl ethers, such as diethyl ether, or monoethers of diols, such as ethylene glycol or propylene glycol, with C₁-C₆ alcohols, amides, such as dimethylformamide, tetrahydrofuran, dioxane, sulfoxides such as dimethyl sulfoxide, sulfones, acetonitrile or butylglycol, and mixtures thereof. Water and alcohols are preferably used. High-boiling solvents may also be employed, examples being polyethers such as triethylene glycol, diethylene glycol diethyl ether, and tetraethylene glycol dimethyl ether. In certain cases other solvents as well find use, examples being light paraffins (petroleum ethers, alkanes, and cycloalkanes), aromatics, toluene, heteroaromatics, and halogenated hydrocarbons such as chlorobenzene. Dicarboxylic esters as well may also find application such as dimethyl succinate, dimethyl adipate, dimethyl glutarate, and mixtures thereof, and the cyclic carboxylic esters may find use as well, such as propylene carbonate and glycerol carbonate, for example.

Preferred solvents are alcohols and ethers, more preferably lower aliphatic alcohols such as methanol, ethanol, 1-propanol, isopropanol, and 1-butanol, and also ethylene glycol or tetrahydrofuran. Preferred are tetrahydrofuran or a mixture of isopropanol and 1-butanol, more preferably in a ratio of 10:1 to 1:10, very preferably 2:1 to 1:2.

It is important that the coordination polymer formed is in solution in the composition obtained. It may be necessary for the composition to be centrifuged or filtered prior to application. Accordingly, preferred coordination polymers are those which are soluble in the selected solvent.

At the same time it is possible through the choice of the solvent to influence the structure of the coordination polymer obtained.

Through the self-assembly of the coordination polymer, the ratio of silane compound and metal compound to the organic compound is variable within wide ranges. This ratio may lie, for example, between 100:1 and 1:100, measured in mmol of silicon to metal ion. The silane compounds and metal compounds are customarily employed in excess relative to the organic compound, preferably in a ratio of 100:1 to 1:1 as measured in mmol (sum total of silicon and metal ions in relation to the organic compound), preferably between 50:1 to 1:1. The ratio may be dependent on the number of coordinative bonds the organic compound is able to develop, and/or on how many different metal centers or silicon centers in the organic compound are able to form at least one coordinative bond. The ratio in this case is preferably at least n:1, when n coordinative bonds can be formed. It is preferably between 50:n and n:1 in that case, preferably between 10:n and n:1. If the organic compound is able to develop coordinative bonds to two metal ions, for example, the preferred molar ratio is between 50:1 and 2:1, preferably between 30:1 and 2:1, more preferably between 10:1 and 2:1.

Another important variable is the ratio between the silane compound and the metal compound. Through the construction of the coordination polymer it is possible, in contrast to the pure silane-based antireflective coatings, to integrate a high level of metal compound into the structure of the resultant SiO₂, without the transmission of the resulting coating becoming significantly poorer. Measured in mmol, the ratio between silicon in the silane compound and the metal ion in the metal compound is preferably between 100:1 and 1:2, more preferably between 100:1 and 1:1, very preferably between 50:1 and 1:1. It may also be between 30:1 and 1:1 or 20:1 and 1:1.

Through the high level of metal compound it is possible not only to influence the refractive index of the antireflective coat. The metal compound may also give the coating other properties, such as increased hardness.

In one preferred development, the metal compound is a titanium compound. As a result, the antireflective coat includes a titanium dioxide fraction, which has photocatalytic properties. As a consequence of this, the antireflective coating may also be given self-cleaning properties. No separate titanium dioxide particles are formed here; instead, the titanium dioxide is integrated into the structure by virtue of the coordination polymer.

The amount of solvent may be varied as a function of the further processing of the composition. In one preferred development of the invention, the amount of silane compound(s) and metal compound(s) in the composition is between 0.001 mol/l and 10 mol/l, preferably between 0.01 mol/l and 1 mol/l, more preferably between 0.1 and 0.8 mol/l.

Depending on the further use of the composition, the solids content of the composition prior to application to the substrate is preferably between 1 and 20 wt %, more preferably between 2 and 5 wt %.

The composition may additionally comprise other constituents. These may be additives customary for optical systems. Examples are plasticizers, sensitizers, wetting assistants, adhesion promoters, flow control agents, antioxidants, stabilizers, dyes, and photochromic or thermochromic compounds.

In one development of the invention, the composition may comprise further optically active substances, for influencing the refractive index, for example. Accordingly it is possible, for example, to add further nanoparticles with a diameter of less than 500 nm (measured by TEM). These may be SiO₂, ZrO₂ and/or TiO₂ particles, for example.

The invention further relates to a method for producing an antireflective coating.

Individual method steps are described in more detail below. The steps need not necessarily be carried out in the order stated, and the method outlined may also have further, unstated steps.

In a first step, an above-described composition is prepared. It may be necessary to adapt the viscosity and concentration of the composition to the coating process used.

In a subsequent step, the composition is applied to a substrate. Coating may take place in accordance with customary techniques, such as by dipping, flooding, knife coating, pouring, centrifugal coating, injecting, brushing, slot coating, meniscus coating, film casting, spinning, or spraying. The viscosity required may be brought about by addition or removal of solvent. Preferred coat thicknesses (in the cured state) are 0.01 to 1 μm. The amount applied is preferably selected, depending on the desired refractive index and the sphere of application, such that coat thicknesses in the range from 50 to 200 nm, preferably 100 to 150 nm, are achieved.

Substrates selected for coating are preferably those suitable for optical applications, such as, for example, glass, ceramic, silicon, metal, semiconductor materials, or (preferably transparent) plastics, such as PET, PE, and PP, in so far as they are suitable for the heat treatment.

Also possible are crystalline materials. In this case it is possible to use any known crystalline material that is suitable for the particular purpose. Examples of preferred crystalline substrates are substrates of silicon, lithium niobate, lithium tantalate, quartz, sapphire, other precious stones or semiprecious stones, and other optical crystals, crystalline detectors, of electromagnetic radiation, for example, such as PbS or selenium, and optical filters (UV, IR, NIR, and VIS), with sapphire being particularly preferred among the crystalline substrates. The crystalline substrate is preferably a transparent substrate. The substrate may also be present, for example, in the form of a surface layer on a support made from a different material.

The substrate may have any desired shape. It may, for example, be planar or domed, such as concave or convex, for example. The substrate may be provided on one side or on both sides with an optical multicoat system. The substrate may be present, for example, in the form of a right-angled or circular plate or a lens, or in any other form. In one preferred embodiment the substrate is a wafer, a screen, an instrument cover glass, a crystalline detector, an optical filter, or a watch glass made of crystalline material. In certain fields of application, the designation “glasses” is customary for crystalline substrates that are used, in commerce or in the art, such as when true glasses as well can be used for the application.

In the subsequent step, the applied composition is heat-treated. In the course of this treatment the coating is heated preferably to temperatures of 400 to 800° C., more preferably 400 to 600° C., and more particularly 400 to 500° C., and is held at this temperature for 1 minute to 1 hour, for example. During this time, the organic (carbon-containing) constituents are completely baked out. An inorganic antireflective coat is obtained in this way.

The method makes it possible in just one step, in particular, in other words with only a single-layer coating, to obtain an effective antireflective coat having a transmission of more than 94%, preferably more than 98%.

The coats produced by the method have a thickness of between 0.01 to 1 μm, preferably in the range from 50 to 200 nm, more preferably 100 to 150 nm.

They further comprise silicon dioxide and at least one metal oxide in accordance with the ratios specified for the composition. The metal oxides are metal oxides of the compounds which have been described for the composition.

Relative to the molar ratios of Si in the silicon dioxide and metal ion in the metal oxide, the coatings obtained have a particularly high fraction of metal oxide while retaining the antireflective properties. The molar ratio is preferably between 100:1 and 1:2, more preferably between 100:1 and 1:1, very preferably between 50:1 and 1:1. It may also be between 30:1 and 1:1 or 20:1 and 1:1.

The coats obtained are notable in particular for their uniform porosity. This may be controlled, as described, through the choice of the organic compound. As a result, coatings of only slight variation in refractive index are obtained.

The surface may also be characterized by its BET surface area.

The optical coatings of the invention are suitable, for example, as interference systems and antireflective systems for the following applications:

Optical filters: antireflection and reflection filters in the sector of the eyewear industry, displays, screens, semiconductor lasers, microlens coating, solar cells, “damage-resistant” laser layers, bandpass filters, antireflective filters, absorption filters, and beam dividers.

Holographic layers: light-guide systems, information storage, laser couplers, waveguides, decoration, and architecture.

Embossable layers: antireflection systems, focusing in detector fields, elimination of flat displays, imaging in photocopiers, fiber optics (incoupling of light).

Lithography: production of microoptical elements such as waveguides, grids, pinholes, diffraction gratings (point gratings), and in the field of display technology, fiber-chip coupling, and imaging optics.

Coatings for solar applications are possible as well, however, such as solar collectors or solar cells.

Further details and features will become apparent from the description hereinbelow of preferred exemplary embodiments in conjunction with the dependent claims. In the context of this description, the respective features may be actualized on their own or as two or more features in combination with one another. The possibilities for achieving the object are not confined to the exemplary embodiments. Thus range figures, for example, always span all—unstated—intermediate values, and all conceivable sub-intervals.

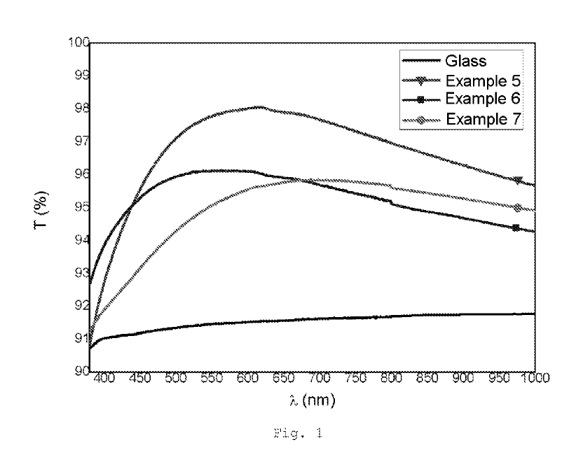

FIG. 1 transmission spectra of the samples of examples 5, 6, and 7 in the visible region. An uncoated glass slide was measured for comparison;

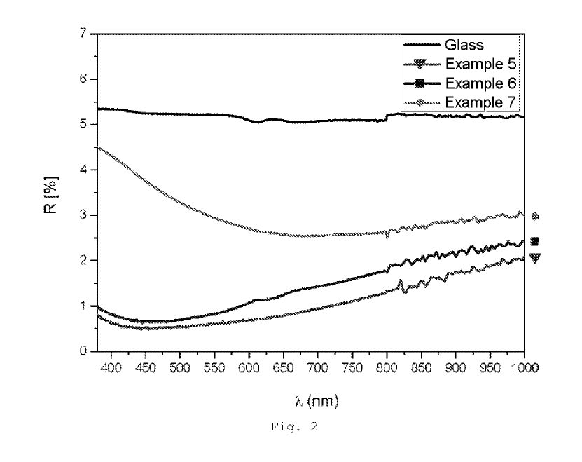

FIG. 2 reflection spectra of the samples of examples 5, 6, and 7 in the visible region;

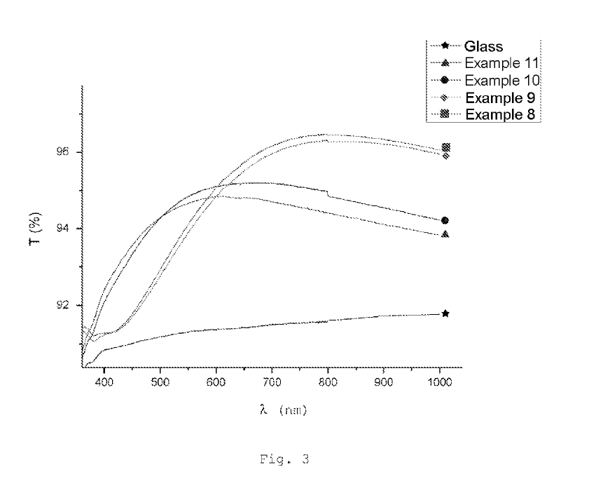

FIG. 3 transmission spectra of the samples of examples 8 to 11. An uncoated glass slide was measured for comparison;

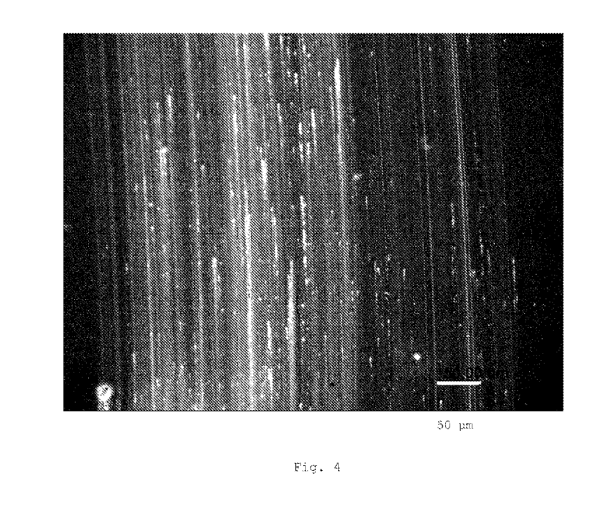

FIG. 4 light micrograph of the surface of example 5 after a scratch resistance test with a pencil of hardness 1H;

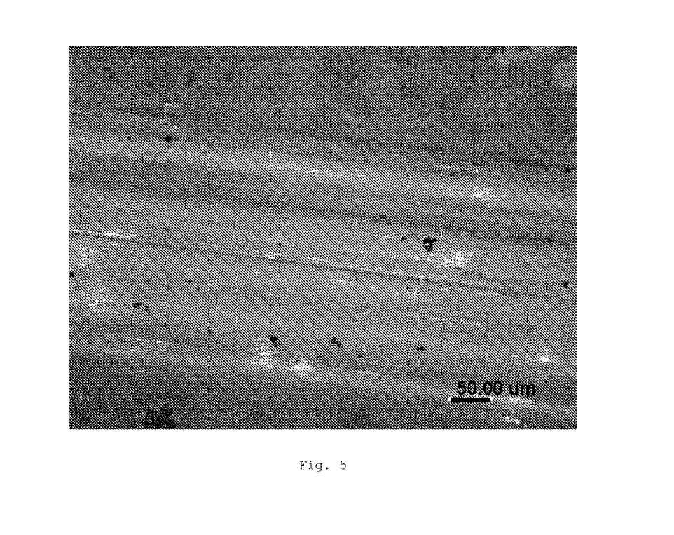

FIG. 5 light micrograph of the surface of example 6 after a scratch resistance test with a pencil of hardness 8H;

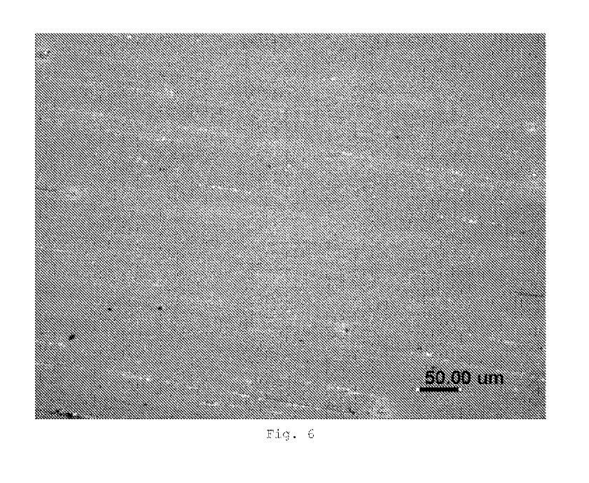

FIG. 6 light micrograph of the surface of example 7 after a scratch resistance test with a pencil of hardness 8H;

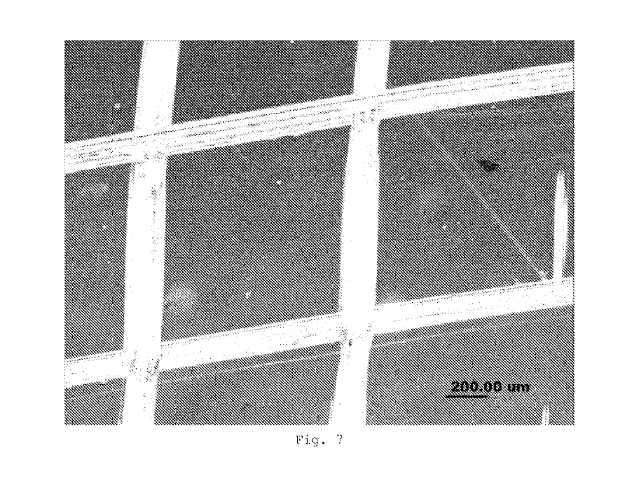

FIG. 7 light micrograph of the area under analysis of the surface of example 5 after the adhesive tape test;

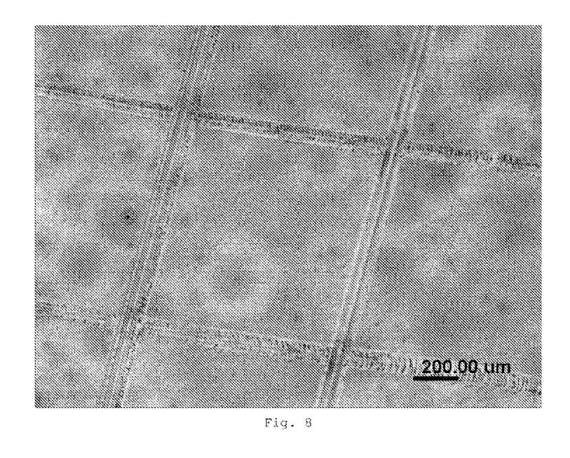

FIG. 8 light micrograph of the area under analysis of the surface of example 6 after the adhesive tape test;

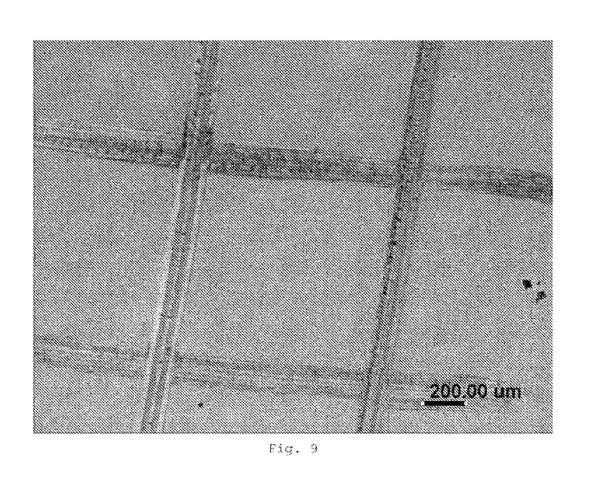

FIG. 9 light micrograph of the area under analysis of the surface of example 7 after the adhesive tape test;

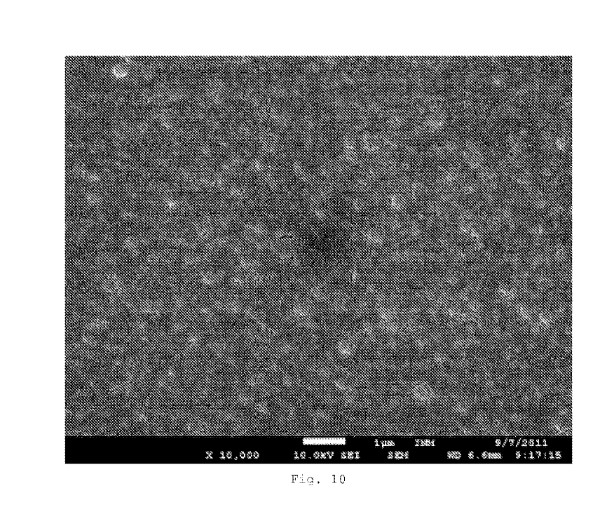

FIG. 10 SEM micrograph of the surface of example 5 with a magnification of 10 000×;

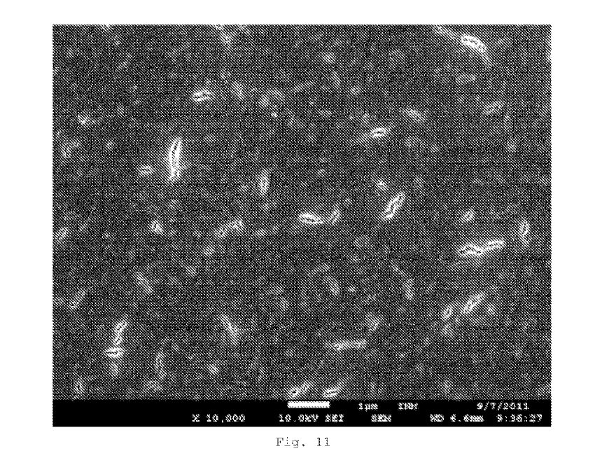

FIG. 11 SEM micrograph of the surface of example 6 with a magnification of 10 000×;

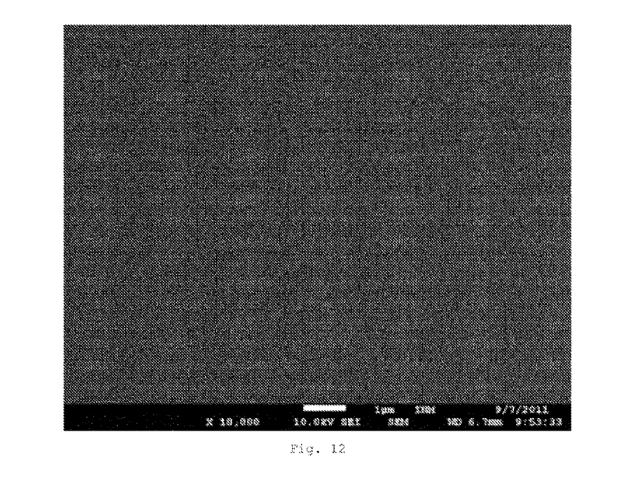

FIG. 12 SEM micrograph of the surface of example 7 with a magnification of 10 000×;

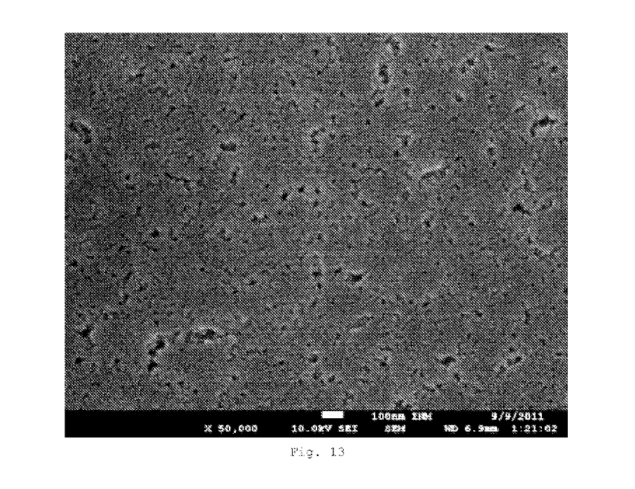

FIG. 13 SEM micrograph of the surface of example 5 with a magnification of 50 000×;

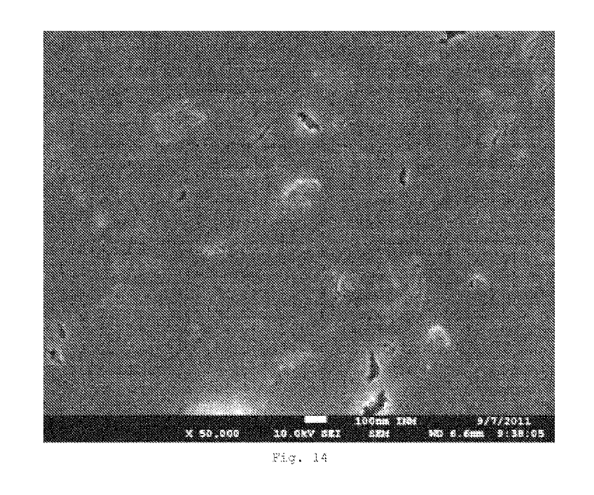

FIG. 14 SEM micrograph of the surface of example 6 with a magnification of 50 000×;

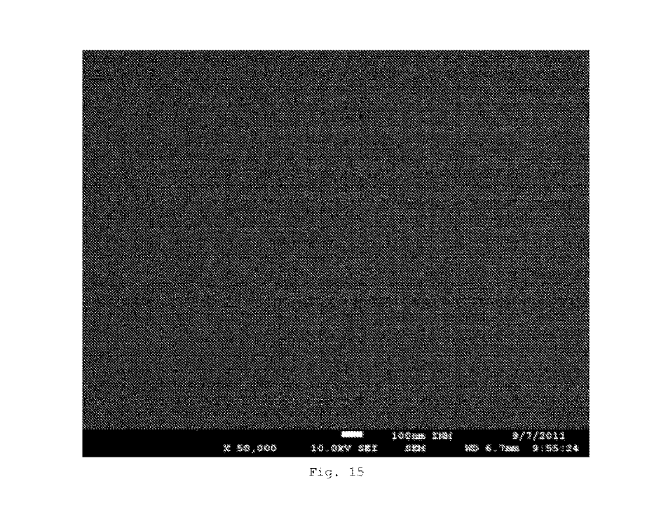

FIG. 15 SEM micrograph of the surface of example 7 with a magnification of 50 000×;

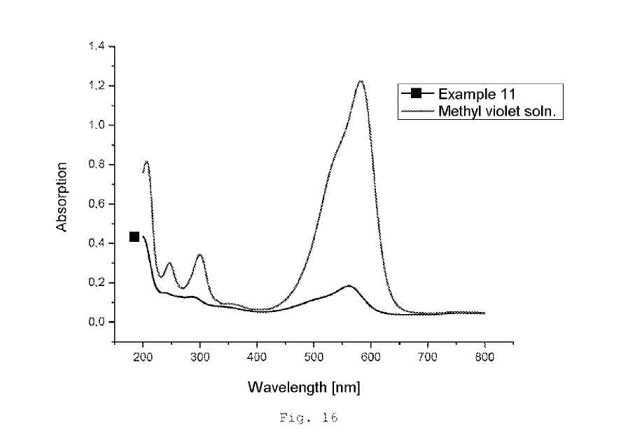

FIG. 16 investigation of the photocatalytic activity of the coating from example 11, with reference to the decomposition of methyl violet.

### MATERIALS AND METHODS

Chemicals

Pyromellitic dianhydride (1,2,4,5-benzenetetracarboxylic 1,2:4,5-dianhydride; Merck Schuchardt OHG); titanium(IV) chloride (TICl₄) (Fluka Analytical, Sigma-Aldrich Chemie GmbH); tetraethoxysilane (TEOS ABCR GmbH & Co. KG); tetrahydrofuran (THF Alfa-Aesar GmbH & Co KG); isopropanol (iPrOH CWR International S.A.S.); n-butanol (n-BuOH Merck Schuchardt OHG). Water used was ultrapure water (Millipore).

Production of the Coatings

The coating compositions produced were applied to glass substrates (Marienfeld). This was done using a dip coating machine. The coatings were produced at speeds of 1, 2, 3, and 4 mm/s. Thereafter all of the coatings were heat-treated at 500° C. for 2 hours.

### EXAMPLE 1

6.67 ml of TiCl₄ were added to 25 ml of water and stirred for 30 minutes.

### EXAMPLE 2

2.73 g (12.5 mmol) of pyromellitic dianhydride and 225 mg (12.5 mmol) of water were added to 50.0 ml of a mixture of iPrOH/n-BuOH (1:1 v/v; by volume) and stirred for 48 hours.

### EXAMPLE 3

2.18 g (0.01 mol) pyromellitic dianhydride and 0.36 g (0.02 mol) of water were added to 22.5 ml of THF and stirred for 48 h.

### EXAMPLE 4

2.73 g (12.5 mmol) of pyromellitic dianhydride and 0.90 mg (0.05 mol) of water were added to 50.0 ml of a mixture of iPrOH/n-BuOH (1:1 v/v) and stirred for 48 h.

### EXAMPLE 5

25.0 ml of mixture of iPrOH/n-BuOH (1:1 v/v) were admixed with 5.0 ml of example 2, 1.30 g (6.25 mmol) of TEOS, and 0.16 ml of example 1, with stirring, and the mixture was stirred for 6 hours.

### EXAMPLE 6

25.0 ml of mixture of iPrOH/n-BuOH (1:1 v/v) were admixed with 2.82 g of example 3, 1.30 g (6.25 mmol) of TEOS, and 0.16 ml of example 1, with stirring, and the mixture was stirred for 6 hours.

### EXAMPLE 7

To example 4, 6.50 g (31.3 mmol) of TEOS and 0.8 ml of example 1 were added (dropwise) with stirring, and the mixture was stirred for 6 hours.

### EXAMPLE 8

To 50 ml of example 4, 3.12 g (14.98 mmol) of TEOS, 5.26 ml of example 1 (dropwise), and 9.00 ml of a mixture of iPrOH/n-BuOH (1:1 v/v) were added with stirring, and the resulting solution was stirred for 6 hours.

### EXAMPLE 9

To 50 ml of example 4, 3.73 g (17.90 mmol) of TEOS, 4.10 ml of example 1 (dropwise), and 9.00 ml of a mixture of iPrOH/n-BuOH (1:1 v/v) were added with stirring, and the resulting solution was stirred for 6 hours.

### EXAMPLE 10

To 50 ml of example 4, 4.36 g (20.93 mmol) of TEOS, 3.15 ml of example 1 (dropwise), and 7.00 ml of a mixture of iPrOH/n-BuOH (1:1 v/v) were added with stirring, and the resulting solution was stirred for 6 hours.

### EXAMPLE 11

To 50 ml of example 4, 4.98 g (23.90 mmol) of TEOS, 2.10 ml of example 1 (dropwise), and 7.00 ml of a mixture of iPrOH/n-BuOH (1:1 v/v) were added with stirring, and the resulting solution was stirred for 6 hours.

The solutions of all of the examples were filtered using 0.2 μm filters prior to dilution.

Characterization of the Coatings

Optical Properties

For all of the coatings produced, the antireflective effect was already apparent directly by observation with the eye.

Both reflection spectra and transmission spectra were recorded using a Cary 5000 spectrometer. The transmission spectra and reflection spectra of examples 5 to 7 are shown in FIGS. 1 and 2.

Measurement of Mechanical Stability

The scratch resistance of the coatings was investigated using an ASTM D3363 pencil scratch test, and verified using a light microscope. Different pencil hardnesses were used to investigate the scratch resistance. The results are shown in FIGS. 4 to 6.

Adhesion Studies

The quality of adhesion of the coatings was investigated using a cross-cut test and by an ASTM D3359 adhesive tape test. The adhesion values measured are 5/5 (this means 100% adhesion in the cross-cut test and 100% adhesion after the adhesive tape test on the cut test area) for examples 6 and 7, and 4/4 for example 5. The test results are also represented in FIGS. 7 to 9, and compiled in table 1.

Refractive Indices (n) and Thickness of the Coatings

The refractive indices and thickness of the coatings were measured by ellipsometry (J. A. Woollan Co, Inc. M-2000 DI, Spectroscopic Ellipsometer). The results are reported in table 2.

Investigations of the Morphology and Microstructure

The morphology and microstructure of the structures were investigated by means of scanning electron microscopy (SEM). Images of the coatings for examples 5, 6, and 7 are represented in FIGS. 10 to 15.

Photocatalytic Activity

FIG. 16 shows a measurement of the photocatalytic activity of the coating from example 11.

The measurement was carried out on a Heraeus Suntest CPS with xenon emitter, the coated slide being covered with 150 g of a solution of 10 mg/l methyl violet in water, and exposed for 10 h. Evaporated water was made up at regular intervals (every 30 min). Measurement took place after the end of the experiment, after 10 hours.

Comparative Experiments

Without the metal compound, i.e., example 1, no useful coats were obtained.

TABLE 1

| | Scratch resistance | Adhesion (cross-cut |
|---|---|---|
| | test (pencil | test/adhesive tape |
| | hardness) | test) |
| Example 5 | 1H | 4/4 |
| Example 6 | 8H | 5/5 |
| Example 7 | 8H | 5/5 |

TABLE 2

| | Thickness (nm) | Refractive index (n) |
|---|---|---|
| Example 5 | 96 | 1.3189 |
| Example 6 | 88 | 1.4090 |
| Example 7 | 104 | 1.4588 |

### REFERENCES CITED

1 F. Guillemot, A. Brunet-Bruneau, E. Bourgeat-Lami, T. Gacoin, E. Barthel and J.-P. Boilot, Chem. Mater. 2010, 22, 2822-2828.

2 M. C. Bautista and A. Morales, Sol. Energy Mater. Sol. Cells 2003, 80, 217-225.

3 B. B. Troitskii, Yu. A. Mamaev, A. A. Babin, M. A. Lopatin, V. N. Denisova, M. A. Novikova, L. V. Khokhlova and T. I. Lopatina, Glass Physics and Chemistry, 2010, 36 (5), 609-616.

4 P. Falcaro, L. Malfatti, T. Kidchob, G. Giannini, A. Falqui, M. F. Casula, H. Amenitsch, B. Marmiroli, G. Grenci and P. Innocenzi, Chem. Mater. 2009, 21, 2055-2061.

5 K. Biswas, S. Gangopadhyay, H.-C. Kim and R. D. Miller, Thin Solid Films 2006, 514, 350-354.

6 O. M. Yaghi and H. Li, J. Am. Chem. Soc. 1995, 117, 10401-10402.

7 C. Janiak, Dalton Trans., 2003, 2781-2804.

8 Jesse L. C. Rowsell, Omar M. Yaghi, Microporous and Mesoporous Materials 73 (2004) 3-14.

9 J. D. Figueroa; T. Fout; S. Plasynski; H. Mcllyried; R. D. Srivastava, Int. J. Greenhouse Gas Contr. 2008, 2, 9-20.

10 Corma, H. Garca and F. X. Llabrés i Xamena, Chem. Rev. 2010, 110, 4606-4655.

1. A composition for producing an antireflective coating, comprising:
a) at least one hydrolyzable silane compound;
b) at least one hydrolyzable metal compound, it also being possible for the compound to be present in partially hydrolyzed and/or condensed form;
c) at least one organic compound having at least two functional coordinative groups or precursors thereof; and
d) at least one solvent.

2. The composition as claimed in claim 1, wherein the organic compound has at least two functional groups or precursors thereof, selected from the group consisting of amino group, carboxylic acid groups, hydroxyl groups, and thiols.

3. The composition as claimed in claim 1, wherein the organic compound is a dicarboxylic, tricarboxylic or tetracarboxylic acid, dicarboxylic, tricarboxylic or tetracarboxylic ester and/or an anhydride and/or ester of such a compound.

4. The composition as claimed in claim 1, wherein the hydrolyzable metal compound is a compound of the formula MXn,
wherein X is a hydrolyzable radical and M is selected from the group consisting of Ia, IIa, IIIa, IVa to VIa, and Ib to VIIIb, and n corresponds to the valence of the metal.

5. The composition as claimed in claim 4, wherein M is selected from the group consisting of Al, B, Sn, Fe, Ti, Zr, V, and Zn.

6. The composition as claimed in claim 1, wherein the constituents a), b), and c) at least partly form a coordination polymer.

7. The composition as claimed in claim 1, wherein a molar ratio of silicon to metal ion in the compounds a) and b) is between 100:1 and 1:2.

8. A method for producing an antireflective coating, comprising:
producing a composition as claimed in claim 1;
applying the composition to a substrate; and
heat-treating the coating.

9. An antireflective coating obtained by the method as claimed in claim 8.

10. A coated substrate with a coating as claimed in claim 9.

11. (canceled)
